(19) United States
(12) Patent Application Publication
(10) Pub. No.: US 2003/0165343 A1
(43) Pub. Date: Sep. 4, 2003

(54) Optoelectronic communication system

(76) Inventor: Dietmar Spanke, Steinen (DE)

Correspondence Address: Felix J. D'Ambrosio, JONES, TULLAR & COOPER, P.C., Eads Station, P.O. Box 2266, Arlington, VA, 22202, US

(21) Appl. No.: 10/376,623

(22) Filed: Mar. 3, 2003

Related U.S. Application Data
(60) Provisional application No. 60/371,710, filed on Apr. 12, 2002.

(30) Foreign Application Priority Data
Mar. 1, 2002 (DE) 10 208 796.2

(51) Int. Cl. H04B 14/04

(52) U.S. Cl. 398/198; 398/140

(57) ABSTRACT

The invention relates to an optoelectronic communication system having a data source (1) and a data sink (2), a transmitting unit (3) and a receiving unit (4) being present for data transmission from the data source (1) to the data sink (2). According to the invention it is proposed that the transmitting unit (3) and the receiving unit (4) are respectively structured as part of the data sink (2), a controllable modulation unit (5) being arranged in the data source (1), and the controllable modulation unit (5) altering the transmitted signal (6.1) of the transmitting unit (3) such that the signal (6.2) reflected from the modulation unit (5) to the receiving unit (4) includes the data information of the data source (1).

The invention relates to an optoelectronic communication system in accordance with the preamble of claim 1.

Optoelectronic communication systems are known from the prior art in the case of which the data are transmitted from a data source with a transmitting unit (for example an IR diode) to a data sink with a receiving unit. However, it frequently happens that insufficient energy is available at the data sources to operate a transmitting unit in order to transmit the data to a data sink. However, the data source receives a large number of data that must be transmitted quickly to the data sink for the purpose of effective processing. This holds, in particular, for field transmitters in automation technology, which must transmit their process data quickly to a control center.

It is therefore an object of the invention to specify an optoelectronic communication system that has a low energy demand for the transmission of data by the data source.

This object is achieved according to the invention by means of the features of claim 1. The dependent claims relate to advantageous refinements and developments of the invention.

The main idea of the invention consists in that a transmitting unit and a receiving unit are respectively structured as part of a data sink, and a controllable modulation unit is arranged in the data source, the controllable modulation unit altering the transmitted signal of the transmitting unit such that the signal reflected from the modulation unit to the receiving unit includes the data information of the data source. As a result of these measures, the modules with a high energy demand, such as, for example, the transmitting unit, are arranged in the data sink and can be supplied with sufficient energy there without problems, while the data source uses the modulation unit, which has a substantially lower energy demand than the transmitting unit.

Modulation of the light signal can be performed, for example, by changing the reflected light intensity and/or by changing the reflected light polarization and/or by changing the reflected light wavelength and/or by changing the phase angle of the reflected light signal.

In a particularly advantageous embodiment, the modulation unit is designed as a reflector unit with a reflecting surface and an associated control unit. Possible advantageous embodiments of the reflector unit are liquid crystal display units, ferroelectric liquid crystal display units, polarizers or mechanical mirrors, in particular micromirrors. Particularly fast transmission rates can be achieved by using ferroelectric display units with short switching times. The reflector surface of the reflector unit is constructed as a point matrix in a particularly advantageous embodiment.

A display unit present in any case in the data source is used as a reflector in a particularly advantageous embodiment.

The transmission link between data source and data sink is designed as an optical conductor in a further embodiment.

Use is made of an optical filter (multiplexer) in a development of the invention, in order to be able to carry out communication from a data sink with a plurality of data sources.

The invention is particularly suitable for use in potentially explosive atmospheres.

The invention is described in more detail below with the aid of the drawing, in which:

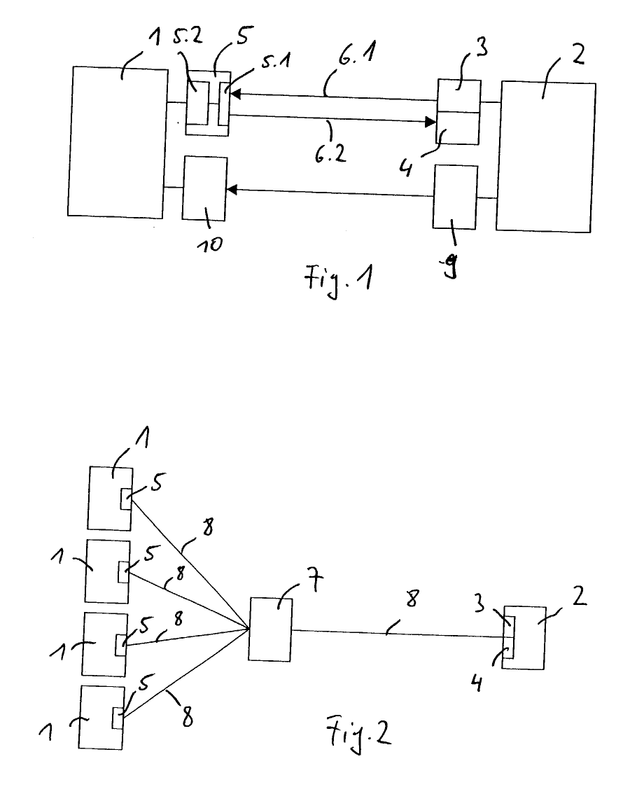

FIG. 1 shows a schematic of a block diagram of the optical communication system according to the invention; and

FIG. 2 shows a schematic of an extended embodiment of the invention.

As may be seen from FIG. 1, the optical communication system comprises a data source 1 with a modulation unit that is designed as a reflector unit 5, and a data sink 2 with a transmitting unit 3 and a receiving unit 4. The transmitting unit 3 sends a light signal 6.1 to the reflector unit 5 for the purpose of transmitting data from the data source 1 to the data sink 2. At said reflector unit, the light signal 6.1 is reflected by a reflector surface 5.1 and transmitted as reflector signal 6.2 to the receiving unit 4. A control unit 5.2 controls the reflector surface such that the reflector signal 6.2 emitted from the light signal 6.1 by reflection includes the data information that is to be transmitted from the data source 1 to the data sink 2. When liquid crystal display elements are used as reflectors, an alteration is achieved by virtue of the fact that, as a function of the data to be transmitted, parts of the reflector surface 5.1 are darkened and therefore absorb the incoming light signal 6.1, and parts of the reflector surface are controlled to be bright and therefore reflect the incoming light signal 6.1. In the case of mechanical mirrors (micromirrors), the incoming light signal 6.1 is altered by virtue of the fact that the mechanical mirrors are arranged such that the light signal 6.1 is completely reflected, or that the mirrors are set such that only a specific fraction of the light signal is reflected. In the case of the use of polarizers, the polarization direction of the incoming light signal 6.1 is rotated or not rotated.

Illustrated for the purpose of carrying out bidirectional communication between the data source 1 and the data sink 2 are an additional transmitting unit 9 and an additional receiving unit 10 for transmitting data from the data sink 2 to the data source 1.

FIG. 2 shows a development of the invention in which a plurality of data sources 1 each having a reflector unit 5 are connected via an optical filter 7 (optical multiplexer) to a data sink 2 via an optical conductor 8. The data sink 2 comprises a transmitting unit 3 and a receiving unit 4. The communication between the data sources 1 and the data sink 2 proceeds as described with reference to FIG. 1.

1. Optoelectronic communication system having a data source (1) and a data sink (2), a transmitting unit (3) and a receiving unit (4) being present for data transmission from the data source (1) to the data sink (2), characterized in that the transmitting unit (3) and the receiving unit (4) are respectively structured as part of the data sink (2), a controllable modulation unit (5) being arranged in the data source (1), and the controllable modulation unit (5) altering the transmitted signal (6.1) of the transmitting unit (3) such that the signal (6.2) transmitted from the modulation unit (5) to the receiving unit (4) includes the data information of the data source (1).

2. Optoelectronic communication system according to claim 1, characterized in that the modulation unit is designed as a reflector unit (5) with a reflecting surface (5.1) and a control unit (5.2).

3. Optoelectronic communication system according to claim 1 or 2, characterized in that the reflector surface (5.1) is constructed as a point matrix, it being possible for the individual points of the point matrix to be controlled by the control unit (5.2).

4. Optoelectronic communication system according to one of the preceding claims, characterized in that the reflector unit (5) is assembled from liquid crystal display elements.

5. Optoelectronic communication system according to claim 4, characterized in that the reflector unit (5) is assembled from ferroelectric liquid crystal display elements.

6. Optoelectronic communication system according to one of claims 1 to 3, characterized in that the reflector unit (5.1) is assembled from mechanical micromirrors.

7. Optoelectronic communication system according to one of the preceding claims, characterized in that the transmission link between data source (1) and data sink (2) is designed as an optical conductor (8).

8. Optoelectronic communication system according to one of the preceding claims, characterized in that an optical filter (7) is present for connecting a plurality of data sources (1) to a data sink (2).
